(19) United States
(12) Patent Application Publication
(10) Pub. No.: US 2010/0063700 A1
(43) Pub. Date: Mar. 11, 2010

(54) 4-wheel drive apparatus for vehicle

(76) Inventor: Tae-Hwan Ha, Seoul (KR)

Correspondence Address: JONES DAY, 222 EAST 41ST ST, NEW YORK, NY, 10017, US

(21) Appl. No.: 10/493,151

(22) PCT Filed: Dec. 14, 2001
(86) PCT No.: PCT/KR01/02168

§ 371 Date: May 30, 2006

(30) Foreign Application Priority Data
Oct. 16, 2001 (KR) 2001/63686

(51) Int. Cl. F16H 61/00; F16H 37/06

(52) U.S. Cl. 701/69; 74/721

(57) ABSTRACT

Disclosed is a 4 wheel drive apparatus for vehicles capable of driving two wheel or four wheels having a simple structure without conventional transfer case. The 4 wheel drive apparatus for vehicles includes a driving shaft connected to an engine, receiving a power from the engine, and having plural driving gears connected to thereon; a transmission including plural change gears geared with the plural driving gears, and an output shaft connected to front wheels and rear wheels of the vehicle; a front power transfer part including a front clutch installed on one end of the output shaft and transferring/blocking a power of the output shaft to the front wheels; a rear power transfer part including a rear clutch installed on the other end of the output shaft and transferring/blocking a power of the output shaft to the rear wheels; and a control part controlling the front and rear power transfer parts in order to restrict a power transferred from the output shaft to the front wheels 20 and the rear wheels.

### TECHNICAL FIELD

The present invention relates to 4-wheel drive apparatus for vehicle, and more particularly to 4-wheel drive apparatus for vehicle which can selectively transfer a power to front wheels or rear wheels by disposing a clutch for connecting and disconnecting a power to the front wheels and the rear wheels on both ends of output of a transmission and by controlling the clutch selectively.

### BACKGROUND ART

Recently, jeeps and automobiles have adopted 4-wheel drive apparatus for vehicle in order to promote acceleration and deceleration ability by transferring a power to both front wheels and rear wheels and then sufficiently transferring an engine torque to load surface, and to improve running stability.

This 4-wheel drive apparatus for vehicle, as shown in FIG. 6, includes the engine 100, the transmission 200 and the transfer case 300 that are arranged according to the direction of a shaft of the vehicle.

The front differential device 111 and the rear differential device 121 are disposed between a pair of front wheels 110 and rear wheels 120 respectively. First propeller shaft 112 is extended between the transfer case 300 and the front differential device 111, and transfers a power to the front differential device 111. Further, second propeller shaft 122 is extended between the transfer case 300 and the rear differential device 121, and transfers a power to the rear differential device 121.

The front wheels 110 and the rear wheels 120 are connected to the front differential device 111 and the rear differential device 121 through the shaft 113, 123 respectively.

The transfer case 300 is installed on one side of the transmission 200, and distributes the power coming from the engine 100 to the front wheels 110 and/or the rear wheels 120.

Hereinafter, the structure and the operation of the transfer case 300 will be omitted, since they are publicly known in the art to which the present invention pertains.

Common examples of a 4-wheel drive apparatus for vehicle and a transfer case used therein are disclosed in U.S. Pat. No. 5,168,956 (Reg. Date Dec. 8, 1992, Namioka) and U.S. Pat. No. 5,520,590 (Reg. Date May 28, 1996, Showalter et al.) and so on.

However, since this prior 4-wheel drive apparatus for vehicles is provided with a transfer case, there are problems as follows. Firstly, the transfer case causes to increase the total weight of the vehicle, and thereby fuel consumption ratio is lowered. Further, manufacturing process is complicated, and manufacturing cost is increased due to many parts required for the transfer case.

### DISCLOSURE OF INVENTION

Therefore, the present invention has been developed to solve the above-mentioned problems. It is an object of the present invention to provide the 4-wheel drive apparatus for vehicles enabling to drive two wheels or four wheels with a simple structure which does not require the transfer case. Thereby, saving of the manufacturing cost, improving of the fuel consumption ratio and improving of steering sensitivity and stability can be accomplished.

It is another object of the present invention to provide the 4-wheel drive apparatus for vehicles enabling to obtain an engine brake effect by a reverse transfer phenomenon of a power in that front wheels and rear wheels are connected to an output shaft and enable an engine to operate during a sudden braking of the vehicle in a state of two wheels drive.

In order to accomplish above objects of the present invention, the 4-wheel drive apparatus for vehicles according to the present invention includes a driving shaft connected to an engine, receiving a power from the engine and having plural driving gears connected to thereon; a transmission including plural change gears geared to the driving gears and an output shaft connected to the change gears and to front wheels and rear wheels of the vehicle; a front power transfer part including a front clutch installed on one end of the output shaft and transferring or blocking a power of the output shaft to the front wheels; a rear power transfer part including a rear clutch installed on the other end of the output shaft and transferring or blocking a power of the output shaft to the rear wheels;

and a control part to control the front and the rear power transfer parts in order to control the power transferred from the output shaft to the front wheels and to the rear wheels.

The control part includes a selecting member for selecting a front wheel drive, a rear wheel drive or a front/rear wheels drive; a mi-com (micro computer) for receiving electrical signals from the selecting member; first and second actuator controlled by the mi-com; first and second operating rods connected to the first and the second actuators and carrying out straight reciprocal motion; and first and second cylinders for receiving the first and the second operating rods and supplying or discharging to/from the front clutch and the rear clutch by the straight reciprocal motion of the first and the second operating rods.

The selecting member includes a front drive button, a rear drive button and a front/rear drive button.

When a driver presses the front drive button of the selecting member of the control part, the mi-com makes the second actuator to operate according to the electrical signals generated by the button, so that the second operating rod is moved into the second cylinder. Thereby, the hydraulic pressure generated in the second cylinder makes the rear clutch to operate, and blocks the power being transferred to the rear wheels. Therefore, the power of the output shaft is transferred to only the front wheels through the front clutch.

Further, when the driver presses the rear drive button in a state of front wheel drive mode, the mi-com makes the first actuator to operate so that the first operating rod is moved into the first cylinder. Whereby, the hydraulic pressure generated in the first cylinder makes the front clutch to operate and blocks the power being transferred to the front wheels. At the same time, the mi-com makes the second actuator to operate so that the second operating rod is moved to outside of the second cylinder. Whereby, the hydraulic pressure being applied to the rear clutch is returned into the second cylinder, and then the power of the output shaft is transferred to only the rear wheels through the rear clutch.

Further, when the driver presses the front/rear drive button, the control part including the mi-com, the first and the second actuators and the first and the second cylinders etc. transfers the power of the output shaft to the front wheels and to the rear wheels simultaneously through the front and the rear clutches, by the above described control.

### BRIEF DESCRIPTION OF DRAWINGS

Other features and advantages of the present invention will become more apparent from the following description taken in connection with the accompanying drawings, wherein:

FIG. 1 is a constitutive view of 4-wheel drive apparatus for vehicles according to a preferred embodiment of the present invention;

FIG. 2 is a broken perspective view of a transmission mounted on the 4-wheel drive apparatus for vehicles in FIG. 1;

FIG. 3 is a view showing a state in which a driving gear and a change gear of the transmission in FIG. 2 are geared to each other;

FIG. 4 is a view showing a state in which a driving gear and a braking gear of the transmission in FIG. 2 are geared to each other;

FIG. 5 is a constitutive view of 4-wheel drive apparatus for vehicles according to another preferred embodiment of the present invention; and

FIG. 6 is a conventional constitutive view of 4-wheel drive apparatus for vehicles in prior art.

### BEST MODE FOR CARRYING OUT THE INVENTION

### Embodiments

Hereinafter, the 4-wheel drive apparatus for vehicles according to the preferred embodiments of the present invention will be described in detail with reference to the, accompanying drawings.

### The First Embodiment

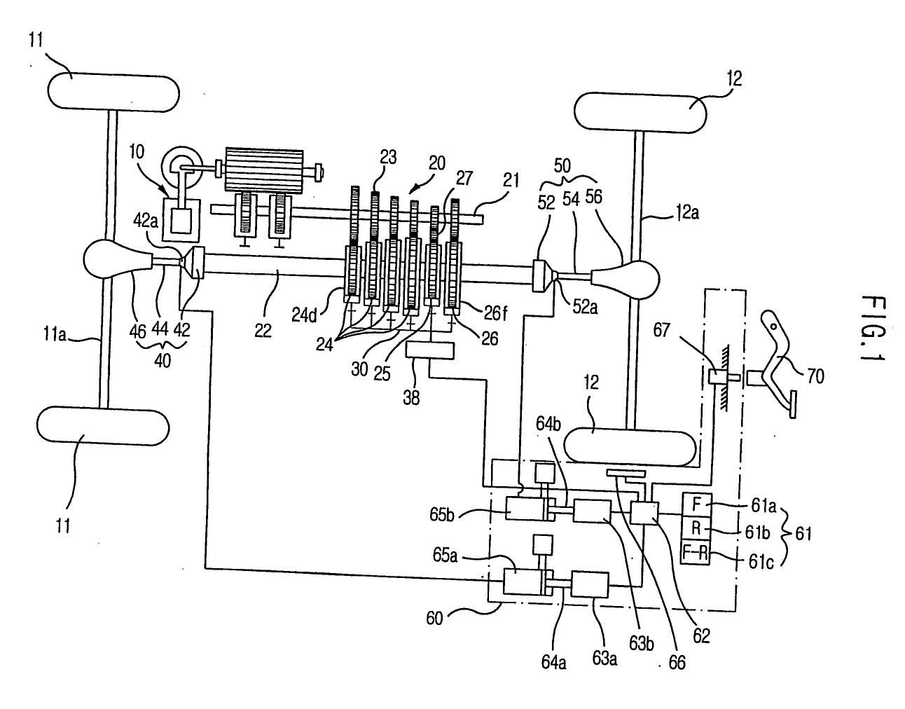

As shown in FIG. 1, the 4-wheel drive apparatus for vehicles according to the first embodiment of the present invention largely consists of the transmission 20 to increase and decrease a power of the engine 10 and to transfer the power to the front wheels 11 and/or the rear wheels 12, the front and the rear power transfer parts 40,50 to be installed between the front wheels 11 and the rear wheels 12 respectively and to transfer and block the power, and the control part 60 to control the front and the rear power transfer part 40,50.

The front wheels 11 and the rear wheels 12 are supported by the shafts 11a,12a respectively.

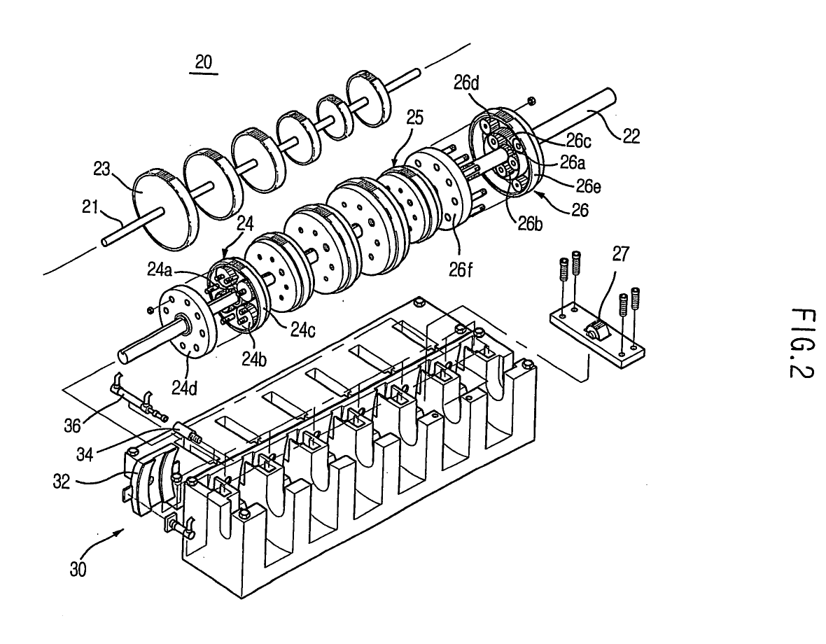

As shown in FIGS. 1 and 2, the transmission 11 includes the driving shaft 21 connected to the engine 10, the output shaft 22 disposed in parallel with the driving shaft 21, the plurality of driving gears 33 connected to the driving shaft 21 and having different size, and the plurality of change gears 24,25 and the braking gear 26 connected to the output shaft 22 and formed to be always geared with the driving gear 23.

The transmission 20 adopted to the present invention is disclosed in U.S. Pat. No. 6,315,689 in detail, therefore it will be briefly explained hereinafter.

The change gear of the transmission 20 is divided in plurality of forward change gears to change the power transferred from the driving shaft 21 in a state of different rotational speed ratio according to running condition of the vehicle, and the backward gear 25 to simultaneously operate with the driving gear 23 in a state in which the idle gear 27 is interposed between the driving gear 23 and the backward gear 25.

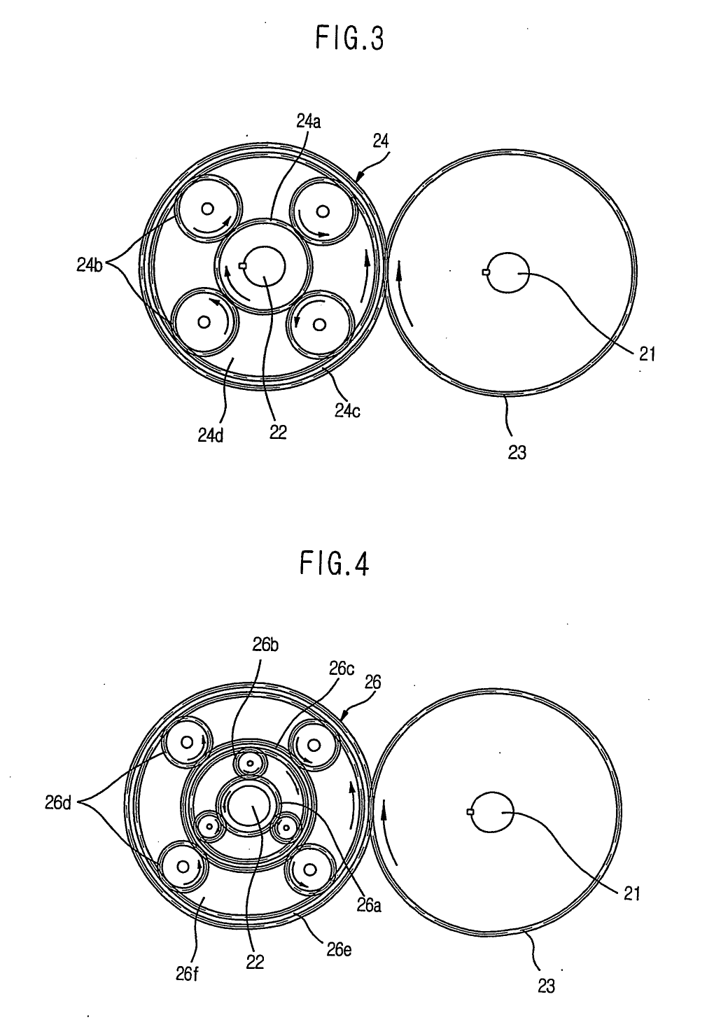

Each of the change gear 24, 25 consists of a planetary gear unit. This planetary gear, as shown in FIGS. 2 and 3, consists of the linear gear 24a fixedly installed on the output shaft 22, a plurality of planetary gears 24b geared to the outer periphery surface of the linear gear 24a, the ring gear 24c having inner geared-surface geared to the planetary gear 24b and outer geared-surface geared to the driving gear 23, and the planetary gear carrier 24d to be installed in symmetry on both ends of the ring gear 24c and to rotatably support the planetary gear 24b.

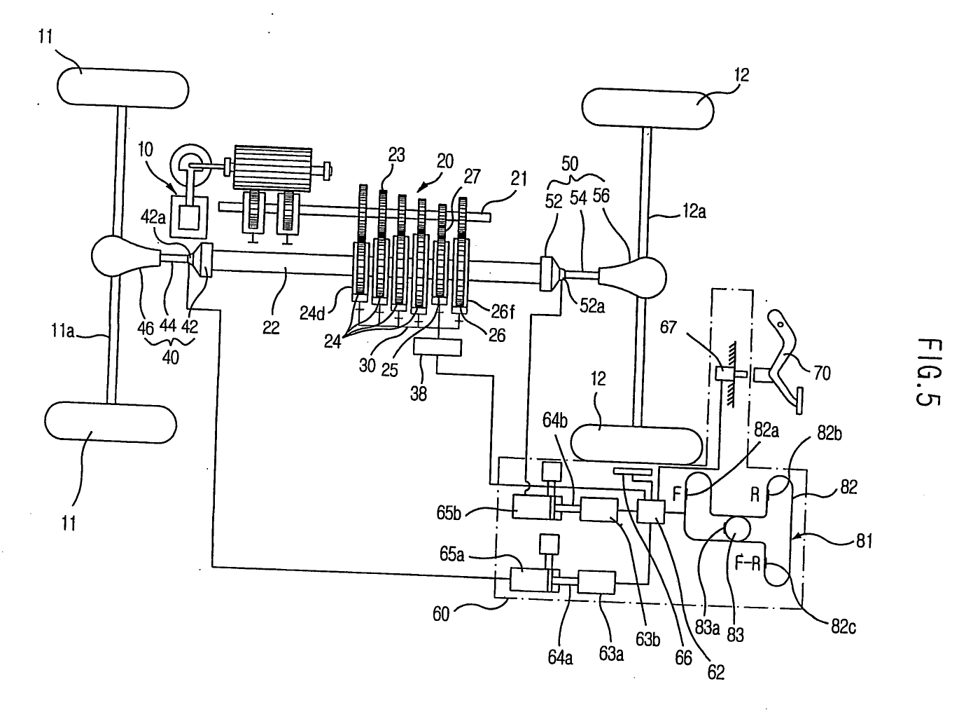

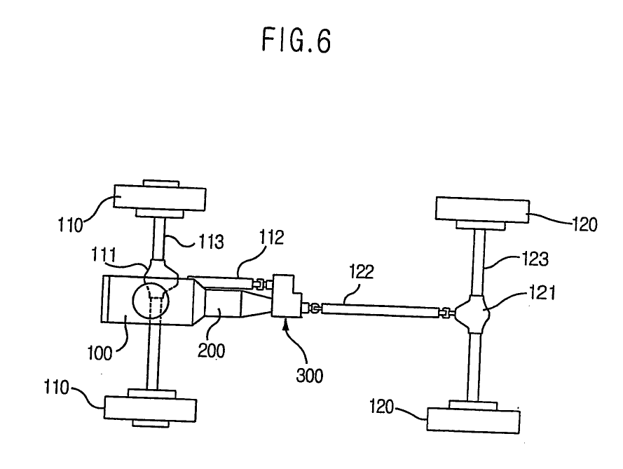

Meanwhile, the braking gear 26 has a constitution to ‘receive the force which makes the output shaft 22 to rotate in reverse direction of the running direction of the vehicle from the driving shaft 21 during a sudden braking of the vehicle. To carry out the constitution, as shown in FIGS. 2 and 4, the braking gear 26 includes the linear gear 26a installed on the output shaft 22, plural first planetary gears 26b geared with the outer periphery surface of the linear gear 26a, first ring gear 26c geared with inner periphery surface of the first planetary gear 26b, the plural second planetary gears 26d geared with the outer periphery surface of the first ring gear 26c, second ring gear 26e having the inner geared-surface geared with the second planetary gear 26d and having the outer geared-surface geared with the driving gear 23, and the planetary gear carrier 26f rotatably supporting the first planetary gear 26b and the second planetary gear 26d.

Further, the transmission 20 further includes the restricting means 30 to restrict or to allow the planetary gear carriers 24d, 26f to rotate. As shown in FIG. 2, the restricting means 30 consists plural brake blocks 32 on which a pad (not shown) enabling to closely contact to the outer periphery surface of the carriers 24d, 26f is attached, plural operating rods 34 to contact and to separate each brake block 32 to/from the carrier 24d, 26f, plural cylinders 36 to drive each operating rod 34, the hydraulic pressure supplying device 38 to supply a hydraulic pressure to the cylinder 36 and to be connected to the mi-com 62 of the control part 60 which will be described later.

Preferably, the brake block 32 has the same curvature as the outer periphery surface of the carrier.

In the above structure, when the operating rod 34 and the brake block 32 are operated by the hydraulic pressure supplied from the hydraulic pressure supplying device 38 and then one of the carriers is restricted to rotate, the power transferred to the ring gear of a corresponding change gear is transferred to the linear gear connected to the output shaft 22 through each planetary gear. Meanwhile, when the carrier is allowed to rotate, the planetary gear revolves around the linear gear thereby the power is not transferred to the linear and the output shaft.

The front power transferring part 40 is installed between the transmission 20 and the shaft 11a of the front wheels 11 and transfers or blocks the power coming from the transmission 20 to the front wheels 11. Further, the power transfer part 40 consists of the front clutch 42 installed on the front end of the output shaft 22, the front propeller shaft connected to the front clutch 42, and the front differential device 46 installed between the front propeller shaft 44 and the shaft 11a.

At this time, the assembled structure of the output shaft 22, the clutch 42, the propeller shaft 44, the differential device 46 and the shaft 11a is the same as the structure which is generally used in the technical field to which the present invention pertains.

In case that the front clutch 42, for example, consists of a friction clutch, a fly wheel is connected to the front end of the output shaft 22. Further, a pressure plate forcedly attached to the fly wheel by a clutch spring, a clutch plate installed between the pressure plate and the fly wheel, and a release fork 42a to transfer an outer force to the pressure plate etc. are provided on the front propeller shaft 44. The friction clutch having above structure is a publicly known art in the technical field to which the present invention pertains, therefore the drawings and the detail description for them will be omitted.

Like the front power transfer part 40, the rear power transfer part 50 consists of the rear friction clutch 52 installed on the rear end of the output shaft 22, the rear propeller shaft 54 connected to the rear friction clutch 52, and the rear differential device 56 installed between the rear propeller shaft 54 and the rear shaft 12a. The constituents and the power transfer structure are the same as those of the front power transfer part 40. The numeral, which is not described, is a release fork of the rear friction clutch 52.

The front and the rear clutches 42, 52 according to the preferred embodiment of the present invention are not restricted to the friction clutch, and various changes in form may be effected without departing from the spirit of the present invention.

The control part 60 controls the front clutch 42 and the rear clutch 52, and selectively transfers the power transferred to the output shaft 22 of the transmission 20 to the front wheels 11 or the rear wheels 12 or to the front and the rear wheels 11, 12.

This control part 60 includes the selecting member 61 installed on one side of a driver' s seat and consisting of the front drive button 61a, the rear drive button 61b and the front/rear drive button 61c, the mi-com 62 to receive electrical signals from the selecting member 61, a pair of actuators 63a, 63b to be controlled by the mi-com 62 and to make the operating rod 64a, 64b to straightly reciprocate, and a pair of cylinders 65a, 65b to receive the operating rods 64a, 64b of each actuator 63a, 63b and to produce a hydraulic pressure due to straight reciprocal motion of the operating rods 64a, 64b.

The pair of cylinders 65a, 65b are connected to the release fork 42a of the front clutch 42 and to the release fork 52a of the rear clutch 52, respectively, through the hydraulic line.

In the control part 60 having above structure, when both or one of the actuators 63a, 63b push(es) the operating rods 64a, 64b to move into the cylinder 65a, 65b by selective operation of the drive button 61a, 61b, 61c, a hydraulic pressure develops in the cylinders 65a, 65b. The developed hydraulic pressure makes the release forks 42a, 52a of the front clutch 42 and/or the rear clutch 52 to operate, and the pressure plate closely attached on the fly wheel connected to the output shaft 22 is separated, thereby the power is blocked from being transferred.

Conversely, when the actuators 63a, 63b make the operating rods 64a, 64b to move to the outside of the cylinders 65a, 65b, the hydraulic pressure applied to the release forks 42a, 52a returns into the cylinders 65a, 65b, and the pressure plate is closely attached to the fly wheel, whereby the blocked power is transferred.

At this time, the mi-com 62 carries out the control operation as follows during operation of the selecting member 61.

When the rear drive button 61b is operated in a state in that the front wheel 11 is operated by the operation of the front drive button 61a, the mi-com 62 controls the front drive button 61a to be returned and controls the front clutch 42 to block the power. Afterwards, when the front drive button 61a is operated in a state in that the rear wheel 12 is operated, the mi-com 62 controls the rear clutch 52 to block the power. Further, when the front/rear drive button 61c is operated, the mi-com 62 controls the front clutch 42 or the rear clutch 52 to transfer the power.

Meanwhile, the control part 60 further includes a speed sensor 66 installed near to the front wheel 11 or the rear wheel 12, and a pedal switch 67 installed on one side of the vehicle, contacted to the brake pedal 70 and generating electrical signals when a driver pedals the brake pedal 70 to the maximum level. These speed sensor 66 and pedal switch 70 are electrically connected to the mi-com 62. When the speed sensor 66 and the pedal switch 67 sense a sudden braking, the control part 60 controls the front and the rear clutches 42, 52 so that the power of the output shaft 22 is simultaneously transferred to the front wheels 11 and the rear wheels 12 during a constant period. Whereby, the power generated in the front wheels 11 and the rear wheels 12 is reversely transferred from the output shaft 22 to the engine 10. At this time, a reverse transfer phenomenon, that is, the front wheels 11 and the rear wheels 12 enable the engine 10 to operate, happens, and thereby an engine brake effect is obtained.

Further, in a state in that a vehicle is running with four wheel drive, when the mi-com 62 senses a sudden braking by the speed sensor 66 and the pedal switch 67, the power being transferred to the front wheels 11 and to the rear wheels 12 is blocked by controlling the hydraulic pressure supplying device 38 and by allowing the change gear 24 and the carrier 24d to be operated to rotate. At the same time, a force acting in reverse direction against the running direction of the vehicle is applied to the output shaft 22 by restricting the carrier 26f of the braking gear 26 using the restricting means 30. Whereby, the rotating force of the output shaft 22 is decreased, and also additional brake effect can be obtained in addition to the braking of the brake pedal 70.

### The Second Embodiment

FIG. 5 is a view showing another preferred embodiment of the selecting member. The selecting member includes the drive selecting plate 82 and the driving lever 83. The drive selecting plate 82 has the front drive contact point 82a, the rear drive contact point 82b and the front/rear drive contact point 82c. Further, the driving lever 83 is installed in the drive selecting plate 82 and has the contact point 83a which is selectively contacted to the front wheels, the rear wheels and the front/rear drive contact points 82a, 82b, 82c. In the selecting member 81 having above structure, when the driving lever 83 is positioned at the front drive contact point 82a, the front wheel 11 is driven. In this state, when the driving lever 83 is moved to the rear drive contact point 82b, the mi-com 62 makes the front actuator 63a and the front clutch 42 to operate, thereby the power being transferred to the front wheels 11 is blocked.

Further, when the driving lever 83 is moved to the front/rear drive contact point 82c, the mi-com 62 controls the front clutch 42 or the rear clutch 52 blocking the power to transfer the power. Whereby, the front wheels 11 and the rear wheels 12 are all driven.

The 4-wheel drive apparatus for vehicles having above structure according to the present invention will be explained in detail referring to the accompanying drawings.

When the engine 10 generates a power, the driving shaft 21 connected to the engine 10 is rotated. And the rotation of the driving lever 21 makes the front change gear 24, the rear gear 25 and the braking gear 26 of the transmission 20 geared with the driving gear 23 to operate. When the restricting means 30 does not restrict the carrier of each gear 24, 25, 26 during the rotation of the gears 24, 25, 26, like described above, the driving force of the driving shaft 21 is not transferred to the output shaft 22 of the transmission 20.

If the transmission 20 is selected at a predetermined change speed step, the pressure supplying device 38 operates the operating rod 34 by supplying a hydraulic pressure to the cylinder 36 of the restricting means 30. Thereby, the pad of the brake block 32 is closely contacted to the carrier of the corresponding gear, and the carrier stops rotating.

For example, when the carrier 24d of any one of front change gear 24 is restricted from rotating, as indicated with an arrow mark in FIG. 3, the outer geared-surface of the ring gear 24c is geared and rotated with the driving gear 23. And, the plural planetary gears 24b are restricted from rotating, so the outer periphery surface thereof is rotated gearing the inner geared surface of the ring gear 24c. Therefore, the linear gear 24a besieged by the planetary gears 24b is rotated, and the output shaft 22 connected to the linear gear 24a is finally rotated. At this time, the power of the driving shaft 21 is conversed depending on the gear ratio of the planetary gear unit, and is transferred to the output shaft 22.

The power transferred to the output shaft 22 as above, in four wheel drive mode of vehicle, is transferred to the front wheels 11 and the rear wheels 12 simultaneously through the front and the rear power transfer parts 40, 50.

In this four wheel drive mode, when a driver presses the front wheel drive button 61a of the selecting member 61 of the control part 60, the mi-com 62 makes the rear actuator 63b to operate following the electrical signals of the drive button 61a so that the rear operating rod 64b is moved into the rear cylinder 65b. Whereby, the hydraulic pressure generated in the rear cylinder 65b makes the release fork 52a of the rear friction clutch 52 to operate, so that the pressure plate is separated from the fly wheel connected to the rear end of the output 22. Thereby, the power being transferred to the rear wheel 12 is blocked. Therefore, the power of the output shaft 22 is transferred to only the front wheels 11 through the front clutch 42, the front propeller shaft 44 and the front differential device 46.

Further, when a driver presses the rear drive button 61b in the front wheel drive mode, the mi-com 62 makes the front actuator 63a to operate following the electrical signals of the button 61b, so that the front operating rod 64a is moved into the front cylinder 65a. Whereby, the power generated in the front cylinder 65a makes the release fork 42a of the front friction clutch 42 to operate so that the pressure plate is separated from the fly wheel connected to the front end of the output shaft 22, therefore the power being transferred to the front wheel 11 is blocked. At the same time, the mi-com 62 makes the rear actuator 63b to operate so that the rear operating rod 64b is moved to the outside of the rear cylinder 65b. Whereby, the hydraulic pressure applied to the release fork 52a of the rear clutch 52 is returned into the rear cylinder 65b, and then the pressure plate is closely contacted to the fly wheel by the clutch spring. Whereby, the power of the output shaft 22 is transferred to only the rear wheel 12 through the rear clutch 52, the rear propeller shaft 54 and the rear differential device 56.

Further, when a driver presses the front/rear drive button 61c, the control part 60 including the mi-com 62, the front and the rear actuators 63a, 63b, and the front and the rear cylinders 65a, 65b etc., transfers the power of the output shaft 22 to the front wheels 11 and to the rear wheels 12 simultaneously through the front and the rear power transfer parts 40, 50, by above control.

Meanwhile, if a vehicle is running in front drive mode, when the speed sensor 66 and the pedal switch 67 sense a sudden braking, the mi-com 62 controls the rear actuator 63b and makes the power of the output shaft 22 to be transferred also to the rear wheels 12. Whereby, the power generated at the front wheels 11 and the rear wheels 12 is reversely transferred from the output shaft 22 to the engine 10. That is, a reverse transfer phenomenon of the power, in that the front wheel 11 and the rear wheel 12 make the engine 10 to be rotated, happens. Thereby, an engine brake effect may be obtained.

Similarly, if a vehicle is running in rear wheel drive mode, when a sudden braking is sensed, the mi-com 62 controls the front actuator 63a and makes the power of the output shaft 22 to be transferred also to the front wheels 11.

Further, if the mi-com 62 is aware of the end of a sudden braking condition by the speed sensor 66 and the pedal switch 67, it controls the front or the rear actuators 63a, 63b so that the original drive mode condition is returned.

Further, if a vehicle is running in four wheel drive mode, when the mi-com 62 senses a sudden braking by the speed sensor 66 and the pedal switch 67, it controls the hydraulic pressure supplying device 38 and allows the carrier 24d of the front change gear 24 under operation to be rotated, thereby all powers are blocked from being transferred to the front wheels 11 and the rear wheels 12. Simultaneously, the mi-com 62 restricts the carrier 26f of the braking gear 26 to be rotated using the restricting means 30. Whereby, as indicated with an arrow in FIG. 4, the rotating force of the driving gear 23 is transferred to the linear gear 26a, in a condition that the rotating direction is reversed, through the second ring gear 26e, plural planetary gears 26d, the first ring gear 26c and plural first planetary gears 26b of the braking gear 26. Therefore, the linear gear 26a attenuates the rotating force of the running direction of the output shaft 22 by applying a reverse force to the running direction of the vehicle to the output shaft 22. Thereby, additional brake effect may be obtained in addition to the braking by the brake pedal 70.

Afterwards, when the mi-com 62 is aware of the end of the sudden braking condition, it controls the hydraulic pressure 38 and releases the restriction of the carrier 26f of the braking gear 26 through the restricting means 30. Also, it restricts the carrier of the predetermined front change gear 24 or rear change gear 25 so that the vehicle is capable of running on any condition required by a driver.

Meanwhile, in the selecting member 81 shown in FIG. 5, the operation of the 4 wheel drive apparatus of the present invention following the position change of the driving lever 83 is the same as that of the above button type selecting member 61, therefore it will not be explained.

As explained above, the 4 wheel drive apparatus for vehicles according to the present invention is provided with a transmission enabling to transfer a power to front wheels and rear wheels using one output shaft, and has a clutch enabling to block/transfer a power to between the output shaft and the front wheels and between the output shaft and the rear wheels respectively. Therefore, even if the complicated and massive transfer case is not used, the power of the engine may be transferred to the front wheels or the rear wheels or the front/rear wheels selectively. Therefore, reduction of the manufacturing cost, increase of fuel consumption ratio and improvement of the steering sensitivity and the stability are carried out.

Further, when a vehicle is braked suddenly during two wheel drive, the front clutch and the rear clutch are controlled so that the power of the output shaft is transferred to the front wheels and the rear wheels simultaneously. Therefore, an engine brake effect by a reverse transfer phenomenon of the power, in that the front wheels and the rear wheels make the engine to operate, can be obtained.

While the present invention has been particularly shown and described with reference to particular embodiments thereof, it will be understood by those skilled in the art that various changes in form and details may be effected therein without departing from the spirit and scope of the invention as defined by the appended claims.

1. A 4 wheel drive apparatus for vehicles comprising: a driving shaft connected to an engine, receiving a power from said engine, and having plural driving gears connected to thereon;
a transmission including plural change gears geared with said plural driving gears, and an output shaft connected to said change gears and to front wheels and rear wheels of said vehicle;
a front power transfer part including a front clutch installed on one end of said output shaft and transferring/blocking a power of said output shaft to said front wheels;
a rear power transfer part including a rear clutch installed on the other end of said output shaft and transferring/blocking a power of said output shaft to said rear wheels; and
a controlling part controlling said front and rear power transferring parts in order to control a power transferred
from said output shaft to said front wheels and said rear wheels.

2. The 4 wheel drive apparatus for vehicles according to claim 1, wherein said control part comprises a selecting member for selecting a front drive, a rear drive or a front/rear drive;
a mi-com for receiving electrical signals from said selecting member;
first and second actuators controlled by said mi-com;
first and second operating rods connected to said first and second actuators and carrying out straight reciprocal motion; and
first and second cylinders for receiving said first and second operating rods and for supplying or discharging to/from said front clutch and said rear clutch respectively by said straight reciprocal motion of said first and second operating rods,
wherein when said actuator makes said operating rod to be moved into said cylinder by the control of said mi-com, a hydraulic pressure generated in said cylinder makes said clutch to operate to block a power being transferred to said front and/or rear wheels, and
when said actuator makes said operating rod to be moved to outside of said cylinder, a hydraulic pressure applied to said clutch is returned into said cylinder so that a power is transferred to said front wheels and/or rear wheels.

3. The 4 wheel drive apparatus for vehicles according to claim 2, wherein said control part further comprises a speed sensor installed on neighboring said front wheels or said rear wheels and a pedal switch being on/off by the control of a brake pedal of said vehicle, said speed sensor and said pedal switch being electrically connected to said mi-com,
wherein when said mi-com senses a sudden brake signal from said speed sensor and said pedal switch, said mi-com commands that said first and said second actuator to make said first and said second operating rod to be moved to outside of said first and said second cylinder respectively, so that a power is transferred to said front wheels and to said rear wheels.

4. The 4 wheel drive apparatus for vehicles according to claim 2, wherein said selecting member includes a front
wheel drive button for inputting electrical signals to said mi-com so that said first actuator makes said first operating rod to be moved outside of said first cylinder and said second actuator makes said second operating rod to be moved inside of said second cylinder;
a rear wheel drive button for inputting electrical signals to said mi-com so that said first actuator makes said first operating rod to be moved inside of said first cylinder and said second actuator makes said second operating rod to be moved outside of said first cylinder; and
a front/rear drive button for inputting electrical signals to said mi-com so that said first and second actuators make said first and second operating rods to be moved outside of said first and second cylinders.

5. The 4 wheel drive apparatus for vehicles according to claim 2, wherein said selecting member comprises a drive selecting plate having a front wheel drive contact point for inputting electrical signals to said mi-com so that said first actuator makes said first operating rod to be moved outside of said first cylinder and said second actuator makes said second operating rod to be moved inside of said second cylinder, a rear wheel drive contact point for inputting electrical signals to said mi-com so that said first actuator makes said first operating rod to be moved inside of said first cylinder and said second actuator makes said second operating rod to be moved outside of said second cylinder, and a front/rear drive contact point for inputting electrical signals to said mi-com so that said first and second actuators make said first and second operating rods to be moved outside of said first and second cylinder; and
a driving lever disposed in said drive selecting plate and having a contact point which is selectively contacted to said front drive contact point, said rear wheel drive contact point or said front/rear drive contact point.

6. The 4 wheel drive apparatus for vehicles according to claim 1, wherein said front power transfer part further comprises a front propeller shaft connected to said front clutch and a front differential device installed on said front propeller shaft, and
said rear power transfer part further comprises a rear propeller shaft connected to said rear clutch and a rear differential device installed on said rear propeller shaft.

7. The 4 wheel drive apparatus for vehicles according to claim 1, wherein said transmission further comprises a controlling gear which is geared with one of said plural driving gears and is connected to said output shaft.

8. The 4 wheel drive apparatus for vehicles according to claim 7, wherein said change gear of said transmission comprises a linear gear fixedly installed on said output shaft, plural planetary gears geared with outer surface of said linear gear, a ring gear having inner geared-surface geared with said plural planetary gears and having outer geared-surface geared with said driving gear, and a planetary gear carrier rotatably supporting said plural planetary gears, and
said braking gear includes a linear gear installed on said output shaft, plural first planetary gears geared with outer periphery surface of said linear gear, first ring gear having inner periphery surface geared with said plural first planetary gear, plural second planetary gears geared with outer periphery surface of said first ring gear, second ring gear having inner geared-surface geared with said plural second planetary gears and having outer geared-surface geared with said driving gear, and a planetary gear carrier rotatably supporting said plural first planetary gears and second planetary gear.

9. The 4 wheel drive apparatus for vehicles according to claim 8, wherein said transmission further comprises a restricting means having plural brake blocks on which a pad enabling to be closely contacted to outer periphery surface of said planetary gear carrier is attached, plural operating rods for closely contacting or separating each said brake block to/from said planetary carrier, plural cylinders for driving each said operating rod, and a hydraulic pressure supplying device for supplying hydraulic pressure to said cylinder.
